(19) United States
(12) Patent Application Publication
(10) Pub. No.: US 2006/0016119 A1
(43) Pub. Date: Jan. 26, 2006

(54) Bait tank insulator

(76) Inventors: Floyd Theodore Ashburn JR., Buford, GA (US); Thomas Mack Farr II, Buford, GA (US)

Correspondence Address: GARDNER GROFF, P.C., 2018 POWERS FERRY ROAD, SUITE 800, ATLANTA, GA, 30339, US

(21) Appl. No.: 11/187,773

(22) Filed: Jul. 22, 2005

Related U.S. Application Data
(60) Provisional application No. 60/590,810, filed on Jul. 23, 2004.

(51) Int. Cl. A01K 97/05; A01K 97/04

(52) U.S. Cl. 43/56; 43/55

(57) ABSTRACT

An article for maintaining the temperature of water housed in a bait tank. The article includes a first sheet or panel made of an insulating material configured for circumferentially enclosing the sides of the tank. Preferably, the panel is multi-layer and defines at least one opening for aligning with a port of the bait tank. Also preferably, the article includes a lid portion for insulating the top of the bait tank. Optionally, the panel can include at least one fishing rod holder for holding a fishing rod therein and at least one pocket for holding a cooling device such as a freezer pack.

### CROSS-REFERENCE TO RELATED APPLICATION

This application claims the priority benefit of U.S. Provisional Patent Application Ser. No. 60/590,810 filed Jul. 23, 2004, which is hereby incorporated by reference in its entirety.

### TECHNICAL FIELD

The present invention relates generally to bait tanks, and, in particular, to an insulated outer cover for bait tanks.

### BACKGROUND OF THE INVENTION

Many avid fishermen typically use bait tanks for keeping baitfish alive while fishing. Typical bait tanks include a plastic tank for containing a quantity of water, typically 10 to 50 gallons, at least one, and preferably two, ports for providing aeration to the water, and a drain near the bottom of the tank for draining water from the tank. The majority of commercially available bait tanks do include some type of aeration system, which oxygenates the water so as to keep the baitfish alive longer. However, many portable, and even non-portable, plastic bait tanks available on the market today do not have a mechanism for maintaining a constant temperature of the water. In warmer weather, even with aeration, baitfish tend to die quickly because of the high ambient temperatures. Thus, many fishermen carry ice and place the ice directly in the water with the baitfish in an attempt to keep the baitfish alive, but even the ice is ineffective in the summer heat. Fishermen have long sought an affordable, effective means of maintaining a more constant bait tank water temperature, alleviating the cost of the purchase of ice and reducing the mortality rates of the baitfish.

Accordingly, it can be seen that a need exists for a way to provide a baitfish tank that can maintain a relatively constant temperature of the water so as to provide a more livable environment for the baitfish. It is to this provision that the present invention is primarily directed.

### SUMMARY OF THE INVENTION

In example forms, the present invention includes an article for maintaining the temperature of water housed in a bait tank having sides, a bottom, and a top. In one aspect, the article includes a first sheet of insulating material, preferably a flexible insulating material, configured for circumferentially enclosing the sides of the tank, wherein the first sheet defines at least one, and preferably two, openings for aligning with ports of the bait tank. The openings can be a pair of notches located at edges of the first sheet that align generally vertically when the panel is installed to the bait tank. Preferably, the article includes a second sheet of insulating material that is releasably coupled to the first sheet for covering the top of the bait tank. Also preferably, one or both of the first and second sheets are multi-layered (i.e., having two or more layers). Optionally, the first sheet includes a fishing rod holder secured to or within the first sheet for holding at least a portion of the fishing rod therein, and a pocket for holding a freezer pack or other cooling device adjacent the bait tank.

In another aspect, the present invention includes an article that has a panel and a lid. The panel is made of an insulating material for at least partially encasing a bait tank, wherein the bait tank has side walls, a top, a bottom and the lid is made of an insulating material and is coupled to the panel for insulating the top of the bait tank. The lid can be a piece separate from the panel that is releasably coupled to the panel with at least one strap. Preferably, the panel and lid are constructed of a flexible material.

In still another aspect, the present invention includes an apparatus which has a bait tank of the type having at least a substantially cylindrical wall, a bottom, and a top, wherein the wall includes at least one port; a panel for insulating the wall of the bait tank, wherein the panel defines at least one opening for exposing the at least one port of the bait tank; and a lid portion for insulating the top of the bait tank. Preferably, the lid portion is releasably attached to the panel. Optionally, the apparatus includes a fishing rod holder releasably secured to the panel for holding at least a portion of a fishing rod therein and/or a pocket for a housing a cooling device.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 depicts a front perspective view of a bait tank and panel having a panel wrapped around the periphery of the bait tank according to a first exemplary embodiment of the present invention.

FIG. 2 depicts a back perspective view of the bait tank and panel of FIG. 1.

FIG. 3 depicts a plan view of the panel of FIG. 1, and showing typical dimensions for use with a standard, commercially available 10-gallon tank.

FIG. 4 depicts a plan view of the panel of FIG. 1, and showing typical dimensions for use with a standard, commercially available 20-gallon tank.

FIG. 5 depicts a plan view of the panel of FIG. 1.

FIG. 6 depicts an exploded view of the panel of FIG. 1 relative to the bait tank.

FIG. 7 depicts an assembly view of the panel and bait tank of FIG. 1, showing the alignment of openings in the panel with openings in the tank.

FIG. 8 depicts a top plan view of a lid for the bait tank of FIG. 1, having a substantially cylindrical body.

FIG. 9 depicts a front perspective view of a bait tank having a panel wrapped around the periphery of the bait tank according to a second exemplary embodiment of the invention.

FIG. 10 depicts a panel for a bait tank according to third exemplary embodiment of the present invention.

### DETAILED DESCRIPTION OF EXAMPLE EMBODIMENTS

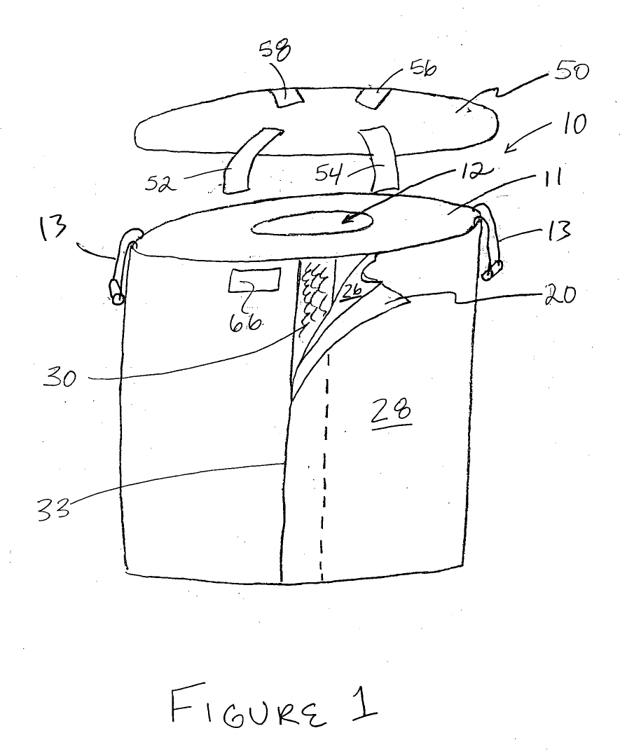

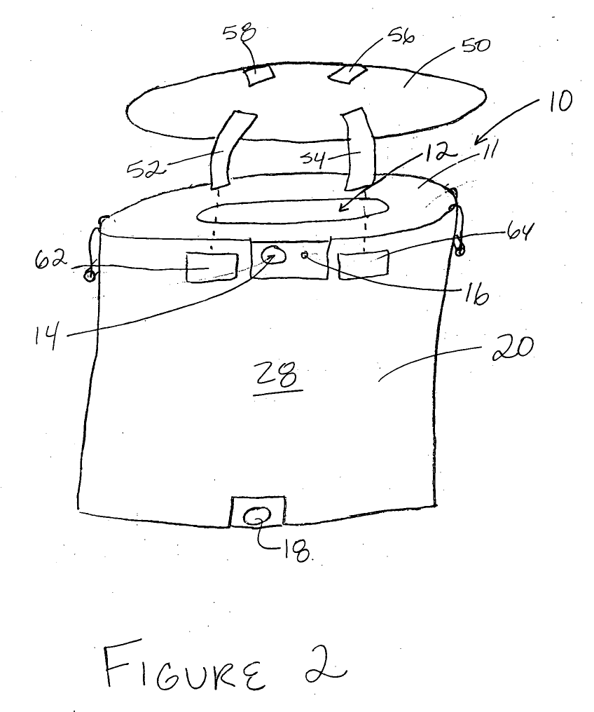

With reference now to the drawing figures, FIGS. 1 and 2 show a bait tank 10 for use with a first exemplary embodiment of the present invention. The bait tank 10 is generally cylindrical, although the bait tank can have various shapes including, but not limited to, semi-cylindrical with a flat back, cubical, conical, or cuboidal. The bait tank 10 has a housing 11 defining an inner chamber 12 for holding a quantity of water, along with one or more baitfish. The bait tank 10 preferably includes first and second aeration holes 14 and 16 for receiving first and second tubes (not shown) that can be connected to a source of oxygenated water or of oxygen, such as an oxygen tank, and a drain 18 for draining water from the chamber 12. Preferably, the drain 18 also includes a drain plug (not shown) for preventing the flow water from the chamber 12 during use. The bait tank 10 also typically includes a removable lid (not shown) for covering the access opening and enclosing the chamber 12, and a pair of rope handles 13 for carrying the bait tank.

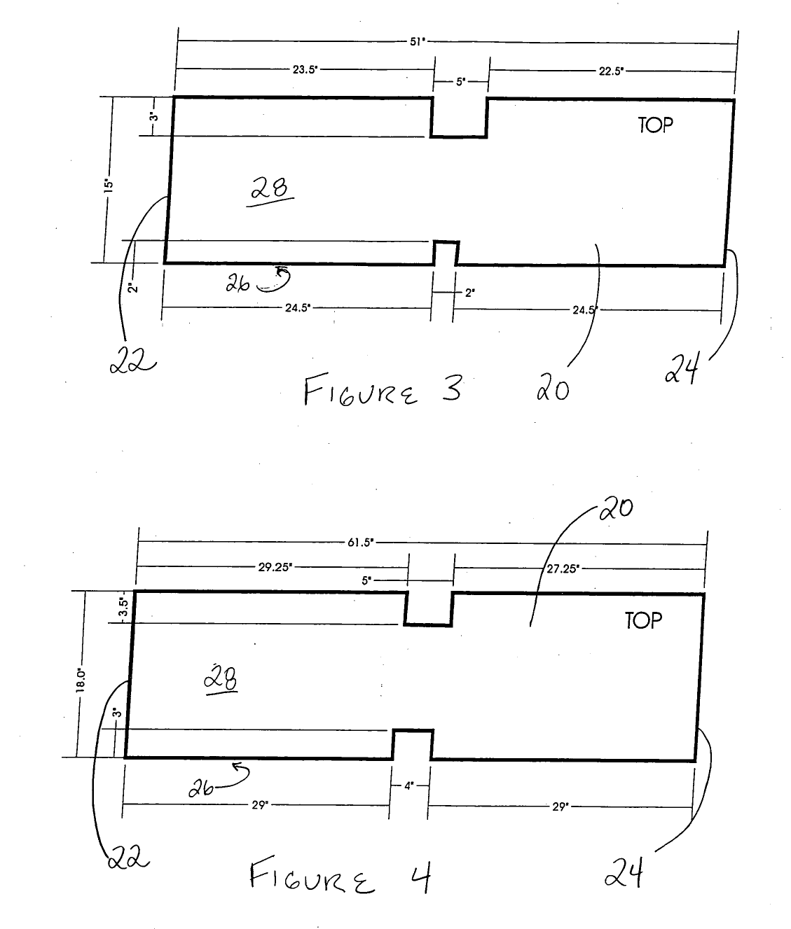

In the first exemplary embodiment, the invention comprises a side panel 20 for wrapping around the outer periphery of the bait tank 10. As shown in FIG. 1, the rope handles 13 extend over the panel 20 such that the bait tank can be carried when the panel is installed thereto. The panel 20 includes a material having thermal insulating properties to insulate the bait tank 10 so as to keep the water in the chamber 12 at a constant temperature relative to the temperature of water that was poured into the chamber 12. Thus, the panel 20 helps to maintain the temperature of the water in the chamber. As depicted more clearly in FIGS. 3-5, the panel 20 preferably is a generally rectangular piece having a first end 22 and a second end 24, as well as an inner surface 26 and an outer surface 28, although various other shapes and sizes can be employed as well.

Preferably, there is a first closure 30 on the outer surface 28 of the second end 24, and a second closure 32 on the inner surface 26 at the first end 22 for interengagement and closing the panel 20 around the bait tank 10 at a seam 33. In the depicted embodiment, the closures 30 and 32 are formed of strips of hook-and-loop material. For example, the closure 30 can be a two-inch wide strip of hook material secured to the length of outer surface 28 by sewing, gluing, or otherwise permanently affixing the hook material to the outer surface. Similarly, the closure 32 can be a two-inch wide strip of loop material secured to the length of the inner surface 26 by sewing, gluing, or otherwise permanently affixing the loop material to the outer surface. It should be noted that the hook material can also be applied to the inner surface 26, while the loop material can be applied to outer surface 28. Also, the hook-and-loop material can be of various shapes and sizes. It should be noted that various others closures can be employed as well without deviating from the scope of the present invention. Closures 30 and 32 can include straps, ties, zippers, buttons, snaps, buckles, or other conventional closure devices that can provide a relatively quick and easy opening and closing of the two parts.

The panel 20 can also include a first notch 34 and a second notch 36 located at the edges of the panel. Preferably the first notch 34 is sized and shaped to accommodate the aeration holes 14 and 16, and the second notch 36 is sized and shaped to accommodate the drain 18, although the notches can be larger or smaller. Preferably, the notches are large enough to accommodate the holes 14 and 16 and the drain 18 but not so large as to interfere with the panel's insulation of the bait tank 10. Although the depicted embodiment shows the notches 34 and 36 as being generally U-shaped, those skilled in the art will understand that the notches 34 and 36 can be any of a variety of shapes and sizes including, but not limited to, C-shaped, triangular, polygonal, or any other shape that exposes the aeration holes 14 and 16 and the drain 18. Additionally, the notches 34 and 36 can alternatively be in the form of a circumscribed hole within the panel 20 for surrounding the aeration holes 14 and 16, either together or individually, and a circumscribed hole within the panel for surrounding the drain 18 (even though they are not “notches” in the ordinary sense) so as to create one or more openings within the panel.

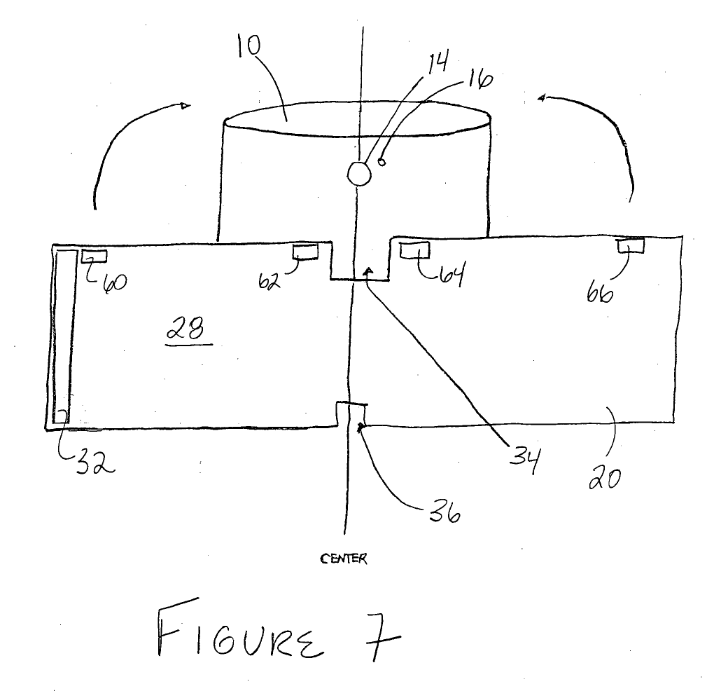

Preferably, the panel 20 is made of substantially flexible material so that it can be rolled up or folded and stored in the interior chamber 12 of the bait tank 10. Also preferably, the panel 20 is multi-layered, although alternatively, the panel can be a single layer panel. As seen more clearly in FIG. 6, the depicted embodiment shows three layers 40, 42, and 44, with the layer 44 being adjacent the bait tank 10 when the panel 20 is installed thereon. Preferably, the second layer 42 includes about ¾ inch thick open cell polyurethane foam sandwiched between the first and third layers 40 and 44, although the present invention contemplates the use of other insulative materials for the layer 42 of various, shapes, sizes, and thicknesses. The first and third layers 40 and 44 can be constructed of a durable, flexible, and water-resistant material such as an acrylic fabric, although the present invention contemplates the use of other suitable materials as well. In the depicted embodiment, the first and third layers 40 and 44 are sewn, glued, or otherwise affixed together with the second layer 42 between them. In an alternative embodiment, the panel 20 is substantially rigid, where one or more of the first, second, and third layers 40, 42, and 44 is substantially inflexible or rigid, and preferably has fold lines for folding the panel flat into a compact arrangement. In another alternative embodiment, the panel is made of a single layer of durable insulating material.

FIG. 3 depicts a plan view of an exemplary panel 20 for use with a standard, commercially available 10-gallon tank. As shown in FIG. 3, the panel 20 has an overall length of about 51 inches and a height of about 15 inches. Although not depicted in the figure, the panel 20 has a thickness of about ¾ of an inch. When the ends 22 and 24 are secured together, there is about a two-inch overlap of the layers 40 and 44, which provides the hook-and-loop connection, while the ends of the insulating layer 42 can touch. The notch 34 has a length of about 5 inches and a height of about 3 inches, while the notch 36 has a length of about 2 inches and a height of about 2 inches. As shown in FIGS. 3 and 6, the notches 34 and 36 are generally vertically aligned along the direction of the height of the panel 20 because typical commercially available bait tanks have aeration holes generally vertically aligned with the drainage hole. The notches 34 and 36 can be generally centered within the length of the panel 20 as depicted, although the positions of the notches can be anywhere along the length of the panel and can even be located, or partially located, at the ends 22 and 24 or corners of the panel. Also, those skilled in the art will understand that the dimensions of the panel 20 can be varied depending on the size and shape of the bait tank.

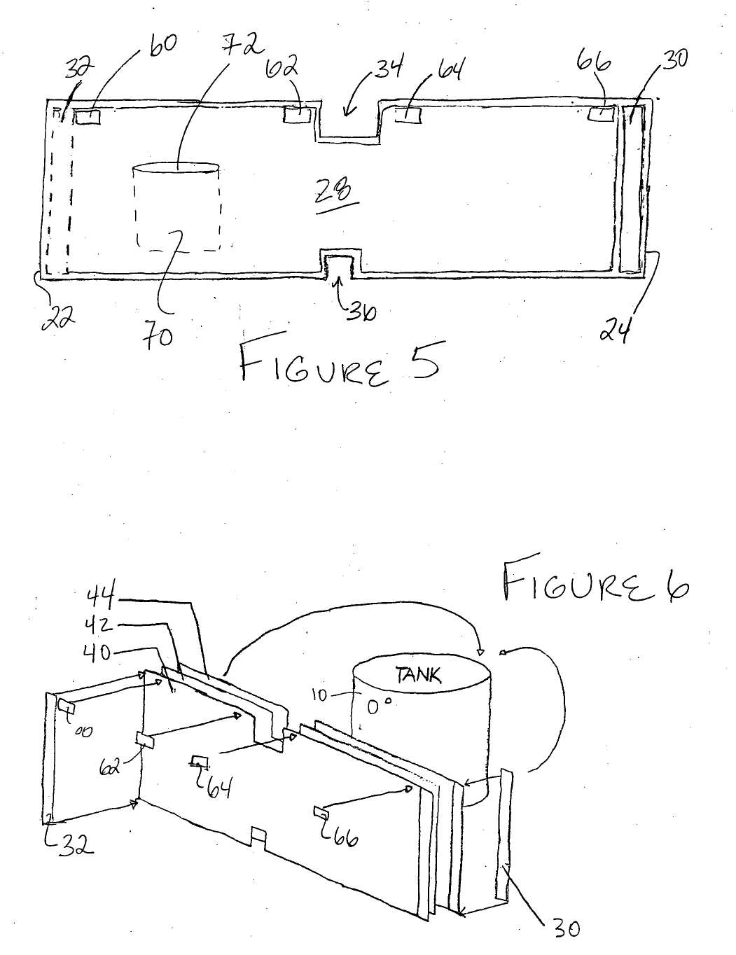

Another exemplary panel 20 for use with a standard, commercially available 20-gallon tank is depicted in FIG. 4. As shown in FIG. 4, the panel 20 has an overall length of about 61.5 inches, a height of about 18 inches, and a thickness of about ¾ of an inch. The notch 34 has a length of about 5 inches and a height of about 3.5 inches, while the notch 36 has a length of about 4 inches and a height of about 3 inches. Similar to FIG. 3, the notches 34 and 36 are generally vertically aligned along the direction of the height of the panel 20. Those skilled in the art will understand that the schematics shown in FIGS. 3 and 4 are merely exemplary, and that various other shapes and sizes can be employed. For example, the length can be somewhat shorter such that the length of panel 20 is equal to the diameter of the bait tank 10, which can be closed by a zipper, buckles, or ties. Or, the length can be somewhat longer such that there is a greater overlap of the material forming the panel 20 when the panel is secured to the bait tank 10. Just as the length can be varied, the height and thickness of the panel 20 can also be varied and still be within the scope of the present invention.

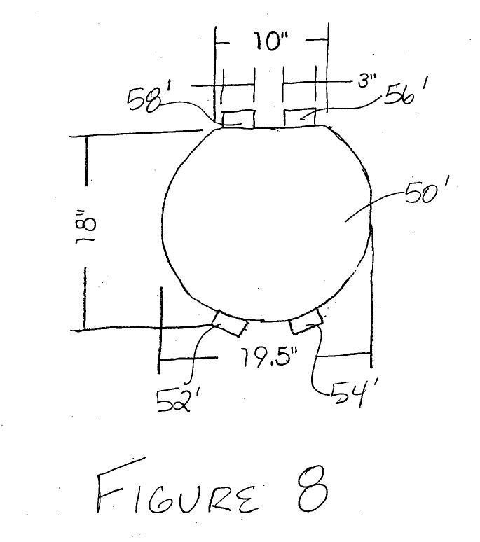

As shown in FIG. 7, the notches 34 and 36 are aligned with the aeration holes 14 and 16 and the drain 18, however the center of the notch 34 is preferably offset to the right to account for the presence and location of both aeration holes. In other words, because the drain hole and one of the aeration holes are generally vertically aligned, with the second aeration hole laterally offset, the notches 34 and 36 are configured as shown to proved access to all three of the tank holes. The ends 22 and 24 of the panel 20 are wrapped around the periphery of the bait tank 10 and secured together at the seam 33 so as to provide a snug fit between the panel and the bait tank.

In addition, the first exemplary embodiment includes a lid portion 50, as depicted in FIGS. 1 and 2. The lid 50 can be constructed similar to the panel 20, with the same or similar foam and fabric as the layers 40, 42, and 44. Preferably, the lid 50 is configured to cover the bait tank 10 plus the width of the panel 20, which allows for a tighter insulating seal. One or more straps can releasably secure the lid 50 to the panel 20. In the depicted embodiment of FIGS. 1-7, four nylon straps 52, 54, 56, and 58 are permanently or semi-permanently secured to the lid 50. For example, one end of each of the four straps 52, 54, 56, and 58 can be sewn to the top portion of the lid, and the other ends of the straps can include a piece of hook or loop material attached thereto for mating with a cooperating portion of the hook or loop material located on the panel 20. FIG. 7 shows four such tabs 60, 62, 64, and 66 of hook or loop material for cooperating with the cooperating portion of the hook or loop material at the ends of the straps 52, 54, 56, and 58. The straps 52, 54, 56, and 58 have appropriate lengths and widths for connecting and securing the lid 50 to the panel 20. Those skilled in the art will understand that the straps 52, 54, 56, and 58 can be made of various shapes, sizes, and materials so as to provide a releasable attachment between the lid 50 and the panel 20. Alternatively, the lid 50 and panel 20 may be coupled together by a zipper or other attachment means. The zipper can extend around the entire circumference of the panel 20 so that the lid 50 can be removed. Or the zipper can extend around most of, but not the entire circumference so that the lid 50 can be flipped up but not detached from the panel 20. Those skilled in the art will also understand that various other attachment devices such as, but not limited to, ties, zippers, buttons, snaps, buckles, or other conventional attachment devices that can provide a releasable attachment between the lid 50 and panel 20 can be employed as well.

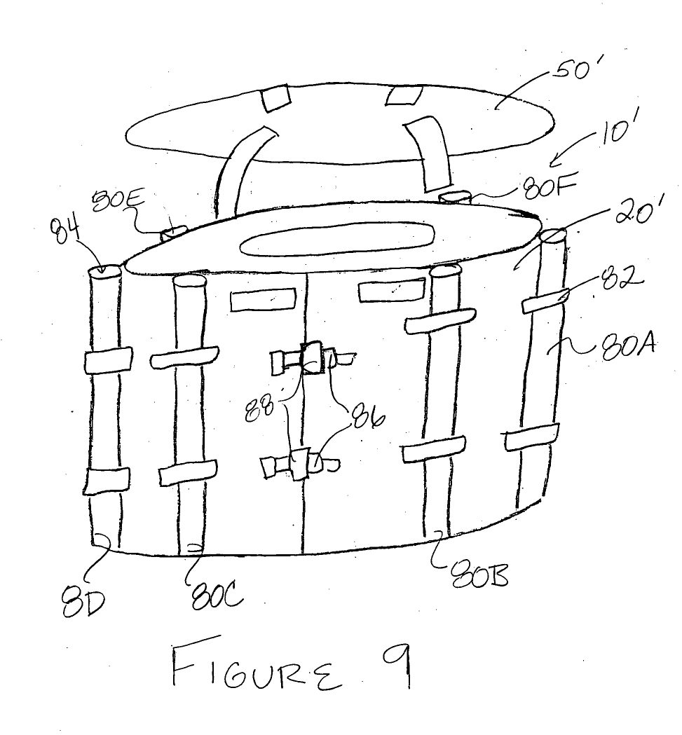

FIG. 8 shows a lid 50′ that is substantially similar to the lid 50, as it provides additional insulation to a commercially available 20-gallon bait tank. In this embodiment, however, the bait tank is substantially cylindrical but with a flat back, and the lid 50′ has a shape conforming to the top of the bait tank.

Thus, for insulation in addition to the panel 20, the user would attach the lid 50 to the panel. For less insulation, such as on cooler days, the user can completely detach the lid 50 and not use it. In such case, the user can attach one or more of the hook or loop material of the straps 52, 54, 56, and 58 to one or more of the tabs 60, 62, 64, and 66 so that the lid can be releasably secured to the outer surface 28 of the panel 20. In the depicted embodiment, the lid 50 can also be used as a “hinged” lid in the sense that two adjacent straps can stay connected to both the lid and the panel 20, thus providing the “hinge”, while the other two straps are detached from the panel. Thus, the user can quickly and easily open the bait tank without completely removing the lid 50.

Optionally, the panel 20 can include one or more pockets 70 for housing a freezer pack, ice, or another cooling device, as shown in FIG. 5. Although only one pocket 70 is shown, typically a series of the pockets are provided. The pocket 70 is preferably located adjacent inner surface 26 of the panel 20, between the second and third layers 42 and 44, so that the cooling device is placed as close as possible to the bait tank 10. In such an embodiment, there is preferably an opening 72 in the panel 20 large enough to insert and remove the cooling device. Additionally, the opening 72 can extend through the first and second layers 40, and 42. Thus, a user can insert a cooling device through the opening 72 and place it within the pocket 70 from the outside while the panel 20 is installed on the tank 20. The opening 72 can be closed with a standard closure device, such as hook-and-loop material, straps, ties, zippers, buttons, snaps, buckles, or other conventional closure devices. In an alternative embodiment, one or more pockets 70 can be defined by a flap attached to the inner surface 26 of the panel 20, so the cooling device can be dropped in or it can be located on the outer surface 28 of the panel 20 and can include one or more standard closure devices. In yet another alternative embodiment, the pockets can be oversized so as to accommodate a plurality of cooling devices.

FIG. 9 depicts a second exemplary embodiment of the invention, showing a bait tank 10′ with a panel 20′ and a top 50′. The bait tank 10′, the panel 20′, and the top 50′ are substantially similar to those just described but with the exceptions noted herein. The panel 20′ includes one or more fishing rod holders 80 releasably coupled thereto with attachment means 82. The fishing rod holders 80 are sized and shaped to accommodate at least a portion of a handle of a conventional fishing rod. Thus, the user can cast a fishing line, secure the handle of the fishing rod within the holder 80, and wait for a fish to bite.

In the depicted embodiment, the attachment means are nylon straps 82 that secure the rod holders 80 to the panel 20′, although the present invention contemplates the use of other conventional attachment means including, but not limited to, hook-and-loop material, straps, ties, zippers, buttons, snaps, or buckles. Or, the panel 20′ can be constructed such that there are vertically elongated pockets located on its outer surface 28′ for removably receiving the rod holders 80. Preferably, the attachment means is durable such that it can secure the rod holder 80 even when forces are applied to the rod holder (such as when a fish bites the line). Alternatively, the rod holders 80 can be incorporated or at least partially incorporated into the panel 20′ itself. For example, the rod holders 80 can be sewn into the panel 20′ between the first and second layers, between the second and third layers, or the rod holders can be placed within the foam layer (i.e., the second layer).

Preferably, the rod holders 80 provide a channel 84 for receiving at least a portion of a handle for a conventional fishing rod. As shown in FIG. 9, there is a plurality of rod holders 80 extending the height of the panel 20 that are formed of 1 and ⅝ inch diameter PVC pipe that is secured to the panel 20′ with one or more attachment means 82. Those skilled in the art will understand that various other rod holders 80 of various shapes, materials, and sizes can be employed as well. For example, the rod holders 80 can have channels that are not circular, but rather are C-shaped, square, rectangular, triangular, or any other suitable shape for housing at least a portion of a fishing rod handle. Additionally, the rod holders 80 can be constructed of a material other than PVC pipe such as, for example, aluminum, plastic, or another suitable material. The rod holders 80 can also extend beyond the height of the panel 20′, or the rod holders can extend along only a portion of the height of the panel. Also, even though the rod holders 80 are depicted as being generally perpendicular to the lid 50′, the rod holders can be offset such that they are not perpendicular to the lid, but instead angled outward for clearance to more easily remove the lid to access the tank.

In lieu of or in addition to the closures 30 and 32, male and female buckle-type connectors 86 and 88 may be located at the ends of a pair of nylon straps permanently affixed to the panel 20′ to provide a more secure connection. The addition of the rod holders 80 adds weight to the panel 20′, and thus, the buckle-type connection is preferable to the hook-and-loop material in this embodiment because the weight of the rod holders can cause the ends of the panel secured with hook-and-loop material to disengage.

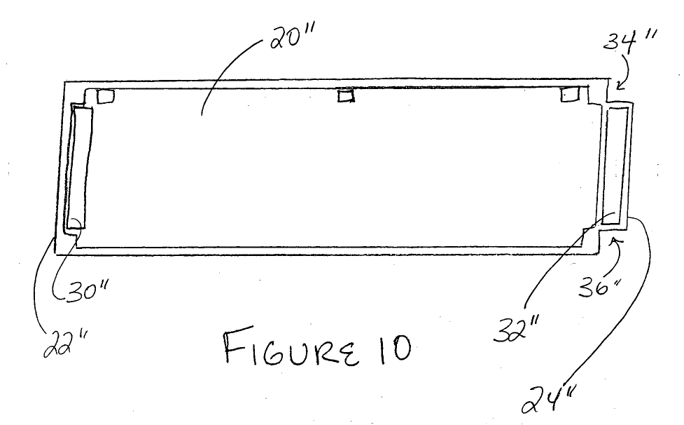

FIG. 10 depicts a third exemplary embodiment of a panel 20″ for a bait tank. The panel 20″ is substantially similar to the panel 20, but with the exceptions noted herein. The panel 20″ has a notch 34″ located at an upper corner thereof, and a notch 36″ located at a lower corner thereof. Thus, when the ends 22″ and 24″ are connected together, the notches 34″ and 36″ form openings for the aeration holes and drain. Also, the panel 20″ of FIG. 10 shows three tabs made of hook or loop material for securing the lid to the panel, although those skilled in the art understand any number or type of closure or tab can be used. Alternatively, the ends may each have two smaller notches that cooperatively form the notches 34 and 36 when the panel is installed on the tank

In an alternative embodiment of the present invention, the panel can be configured as a notchless rectangular band sized to fit between the aeration holes and drain so as to provide some insulation. Thus, although not optimal, the panel is sized and shaped to cover the periphery of the bait tank that is located in a circumferential band between the aeration holes and drain. Thus, the circumferential areas above the aeration holes and below the drain would not be insulated.

In another alternative embodiment, the panel 20′ can be a closed-top sleeve that essentially fits over the entire bait tank, including the aeration holes and tubes and the drain. Thus, the top and sides of the bait tank would be insulated.

In another alternative embodiment of the invention, the panel 20 has a continuous “closed-loop” side sheet (instead of ends that detachably couple together by hook-and-loop material). The panel 20 can include an elastic section for permitting the sheet to be stretched slightly for fitting over the tank. Or the panel 20 can be made of an insulating material with elastic properties.

In yet another alternative embodiment of the present invention, the panel 20 has a bottom. The bottom can be fixedly attached to the sides of the panel 20, for example, by two straps positioned so that the panel can be collapsed into a flat arrangement. Or the bottom can be coupled to the panel sides by hook-and-loop material, zippers, ties, buttons, snaps, buckles, or other conventional attachment devices that can provide a removable attachment.

In still another alternative embodiment, the panel can be a universal panel that can be adapted to a variety of commercially available bait tanks. Preferably, the universal panel is sized and shaped to accommodate a large bait tank. For example, the panel may have a length and height sufficient for use with a 20-gallon tank. Such a panel may also have a foldable, removable, elastically retractable, or otherwise displaceable portion so that the height of the panel can be reduced for use with a shorter 10-gallon tank. And the panel may have a series of closures (e.g. a series of hook-and-loop strips) arranged for alignment and engagement with the panel ends further overlapping as when using the panel with the 10-gallon tank. The panel can include one or more seams for folding the layers onto themselves so as to provide a fit for a smaller bait tank. Optionally, the user can cut along the seams for fitting a smaller tank. Alternatively, the material can be made of elastic or another stretchy material that allows the panel to fit on a various sizes of bait tanks.

Accordingly, it can be seen that the present invention provides fishermen with a relatively inexpensive panel and a lid for insulating a standard, commercially available bait tank. In addition, the panel and lid of the present invention is substantially flexible such that when the bait tank is not in use, the panel and lid can be rolled up or folded and stored within the inner chamber 12 of the bait tank.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been described with reference to preferred and exemplary embodiments, it will be understood by those skilled in the art that a variety of modifications, additions and deletions are within the scope of the invention, as defined by the following claims.

What is claimed is:

1. An article for maintaining the temperature of water housed in a bait tank having one or more sides, a bottom, and a top, comprising:
a first sheet of insulating material configured for circumferentially enclosing the sides of the tank, the first sheet defining at least one opening therein for aligning with a port of the bait tank to permit access to the bait tank port when the sheet is installed on the bait tank.

2. The article of claim 1, further comprising a second sheet of insulating material having at least one portion that is releasably coupled to the first sheet, wherein the second sheet is configured to cover the top of the bait tank.

3. The article of claim 1, wherein at least one of the first and second sheets comprises multiple layers.

4. The article of claim 1, wherein the at least one opening includes first and second openings.

5. The article of claim 4, wherein the first opening is in the form of a notch located at an upper edge of the first sheet, and the second opening is in the form of a notch located at a lower edge of the first sheet.

6. The article of claim 5, wherein the first and second openings are generally vertically aligned when the panel is installed on the bait tank.

7. The article of claim 6, wherein the bait tank has two aeration ports and a drain port, and the first and second openings are laterally offset from each other in a configuration wherein the first opening permits access to both of the aeration ports and the second opening permits access to the drain port.

8. The article of claim 1, wherein the first sheet is installed around the sides of the bait tank and includes a closure for securing a first end of the first sheet to a second end of the first sheet.

9. The article of claim 1, wherein the first sheet includes a flexible material.

10. The article of claim 1, further comprising a fishing rod holder secured to or within the first sheet for holding at least a portion of the fishing rod therein.

11. The article of claim 1, wherein the first sheet defines a pocket therein for housing a cooling device.

12. A method of using the article of claim 1 to maintain the temperature of the water in the bait tank, comprising:
aligning the at least one opening of the article with the port of the bait tank;
wrapping first and second ends of the article around the bait tank in a direction towards one another so that the first end contacts the second end; and
fastening the two ends together with a closure.

13. An article for maintaining the temperature of water in a bait tank having side walls, a top, and a bottom, comprising:
a panel made of an insulating material for at least partially encasing the side walls of the bait tank; and
a lid made of an insulating material for at least partially covering the top of the bait tank.

14. The article of claim 13, wherein the lid is releasably coupled to the panel in a configuration permitting the lid to be displaced to access the bait tank during use.

15. The article of claim 14, wherein the lid is attached to the panel with at least one detachable strap.

16. The article of claim 13, wherein the lid and the panel are two separate pieces.

17. The article of claim 13, wherein the panel defines at least one opening for exposing at least one port of the bait tank.

18. The article of claim 13, wherein at least one of the panel and the lid are constructed of a flexible material.

19. The article of claim 18, wherein the panel and the lid each comprise at least two layers of material.

20. An apparatus, comprising in combination:
a bait tank of the type having a circumferential side wall, a bottom, and a top, wherein the wall includes two upper aeration ports and one lower drain port, wherein the drain port and a first one of the aeration ports are generally vertically aligned and a second one of the aeration ports is laterally adjacent the first aeration port;
a side panel for insulating the wall of the bait tank, wherein the panel defines one upper opening for exposing the upper aeration ports of the bait tank and one lower opening for exposing the lower drain port, wherein the upper and lower panel openings are generally vertically aligned but laterally offset to permit access to all of the aeration and drain ports; and
a lid panel for insulating the top of the bait tank, wherein the lid panel has at least one portion that is releasably attached to the panel.

21. The apparatus of claim 20, further comprising a fishing rod holder releasably secured to the panel for holding at least a portion of a fishing rod therein.

22. The apparatus of claim 20, wherein the panel defines a pocket for a housing a cooling device.
